(19) United States
(12) Patent Application Publication
(10) Pub. No.: US 2012/0321412 A1
(43) Pub. Date: Dec. 20, 2012

(54) COVER FOR A STUD AND NUT ASSEMBLY

(75) Inventors: Eric Nelson Lonn, Lafayette, IN (US); Scott Neece, Lincoln, IL (US); Larry Keith Moore, Lafayette, IN (US); Donald Lemont Stamets, Bloomington, IL (US)

(73) Assignee: Caterpillar Inc., Peoria, IL (US)

(21) Appl. No.: 13/163,789

(22) Filed: Jun. 20, 2011

(51) Int. Cl. F16B 37/14; F16B 37/00

(52) U.S. Cl. 411/431

(57) ABSTRACT

A cover for a stud and nut assembly. The cover includes a first section and a second section. The first section includes a first inner surface extending from an open end. Further, the first section includes two protruding members configured on the first inner surface. The second section is integral with the first section. The second section includes a second inner surface which extends to a closed end.

### TECHNICAL FIELD

The present disclosure relates to a protective covering, and more specifically relates to a cover for a stud and nut assembly used in an engine.

### BACKGROUND

A cover is normally used to protect an exposed end of a stud and nut assembly in an engine. U.S. Pat. No. 4,907,929 discloses to a cover which is provided over a bolt and nut assembly, such that a first internal cavity section of the cover surrounds the nut and a second internal cavity section engages with the threads on the exposed bolt.

Further, U.S. Pat. No. 5,590,992 discloses a one-piece reusable cover including a closed top end portion and a generally cylindrical sidewall extending from the closed top end portion to define a hollow cavity within the cover. Threads are provided within the internal cavity of the cover which is adapted to mate with the external threads on the bolt.

### SUMMARY OF THE DISCLOSURE

In one aspect of the present disclosure, a cover for a stud and nut assembly is provided. The cover comprises a first section and a second section. The first section includes a first inner surface extending from an open end. The first section also includes two protruding members configured on the first inner surface. The second section is integral with the first section. The second section includes a second inner surface extending to a closed end.

Other features and aspects of this disclosure will be apparent from the following description and the accompanying drawings.

### BRIEF DESCRIPTION OF THE DRAWINGS

FIG. 1 is a schematic view of an engine, according to one embodiment of the present disclosure;

FIG. 2 is a cross-sectional view of a stud and nut assembly along with a cover, according to an embodiment;

FIG. 3 is perspective view of the cover, according to an embodiment;

FIG. 4 is a top view of the cover of FIGS. 3; and

FIG. 5 is a side view of the cover taken along a second plane.

### DETAILED DESCRIPTION

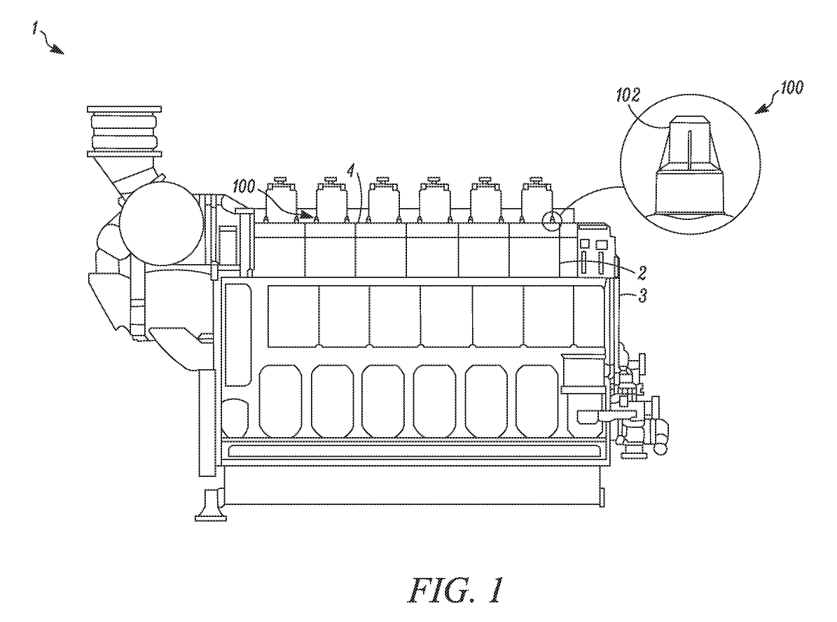

FIG. 1 illustrates an engine 1 according to an embodiment of the present disclosure. The engine 1 may include one or more cylinders 2, such that the one or more cylinders 2 may be fitted in any suitable configuration including an inline arrangement, a radial arrangement, a “V” arrangement, to name a few. The engine 1 has an engine block portion 3 which may include a plurality of substantially identical blocks each of which has the cylinders 2 formed into it. The engine block portion 3 may have a plurality of bores through which a fastener may be used to attach a cylinder head portion 4 with the engine block portion 3. A person of ordinary skill in the art will appreciate that the engine 1 depicted in the figure is merely on an illustrative basis and does not limit the scope of the disclosure.

The engine 1 may include a number of other systems (not shown in the figure) such as a fuel system, a cooling system, a brake system, and the like. Moreover, the engine 1 may be a diesel or gasoline engine, an internal combustion engine, a natural gas engine, without any limitation. The engine 1 may be used to power any machine or other engine powered application such as, trucks, earth moving equipments, marine propulsion systems, generators, and the like.

In an embodiment, the cylinder head portion 4 is attached to the engine block portion 3 by means of a stud and nut assembly 100. In order to protect the stud and nut assembly 100, the stud and nut assembly 100 may further be fitted with a cover 102 as depicted in the FIG. 1. In one embodiment, the cover 102 may be composed of a plastic material, either solely or in combination with another material, for example, but not limited to, fiberglass filled nylon material. In various other embodiments, the cover 102 may be composed of any other type fiber reinforced plastic.

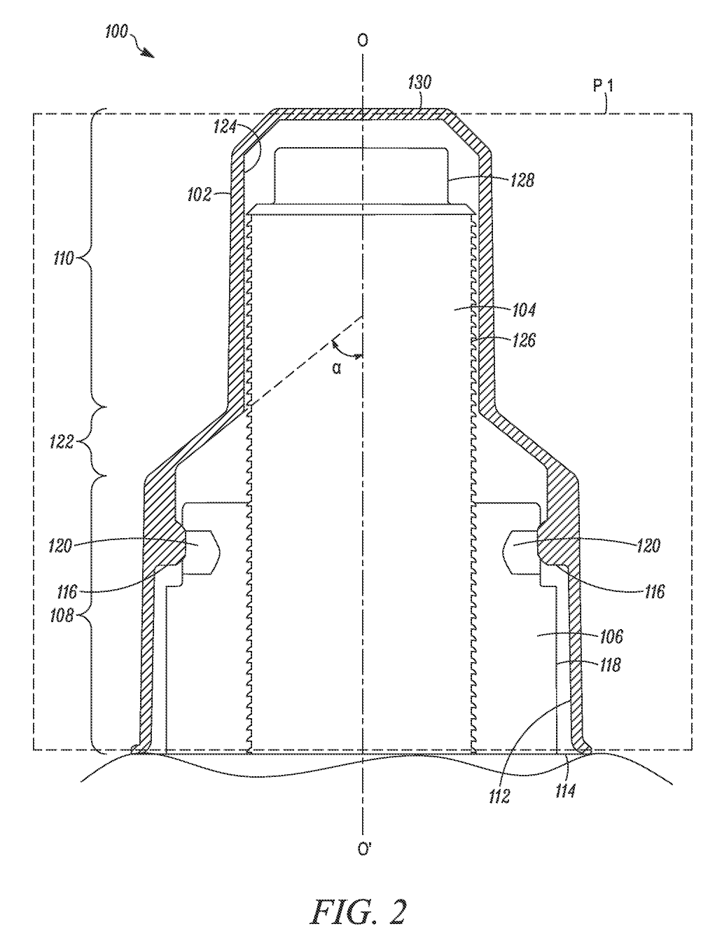

FIG. 2 illustrates the cross-sectional view of the stud and nut assembly 100 with the cover 102 fitted on a stud 104 and a nut 106. As shown in the FIG. 2, the cover 102 may include a first section 108 and a second section 110. The first section 108 includes a first inner surface 112 extending from an open end 114. The first section 108 may have an inner diameter greater than a diameter of the nut 106 by tolerance to provide a loose fit, such that the cover 102 may be easily fixed or removed from the stud and nut assembly 100.

In an embodiment, two protruding members 116 may be configured on the first inner surface 112. The two protruding members 116 may be located in a first plane P1 at opposite ends, on the first inner surface 112 of the first section 108. An outer surface 118 of the nut 106 may have notches 120 located at a predetermined height. During assembly, the notches 120 may receive the protruding members 116 and fasten the cover 102 with the nut 106 to provide an interference fit. The two protruding members 116 engaged in the notches 120 may prevent the cover 102 from disengaging the stud and nut assembly 100 and also form a tight seal at the open end 114. Moreover, in one embodiment, the protruding members 116 may engage in an upper portion of the notches 120 such that a minimum gap of approximately 1 mm may be present between the protruding members 116 and the lower portion of the notches 120 to consistently maintain the seal at the open end 114. A person of ordinary skill in the art will appreciate that the gap may accommodate thermal growth of the cover 102, and the nut 106, that may expand during the operation of the engine 1.

In another embodiment, the predetermined height of the notches 120 may vary, such that a first set of the notches 120 may be positioned at a first height and a second set of the notches 120 positioned at a second height. In such a case, depending on a length of the stud and nut assembly 100 being protected, the two protruding members 116 may engage in either the first or the second set of the notches 120 on the nut 106.

A tapered section 122 may be provided between the first section 108 and the second section 110. The tapered section 122 may form an angle a lying between 45 degrees and 60 degrees with respect to a central axis OO′ of the cover 102. The second section 110 may be disposed integral with the first section 108 such that the second section 110 may include a second inner surface 124 extending to a closed end 130. The second inner surface 124 may be a smooth surface. A diameter of the second inner surface 124 of the second section 110 is greater than a diameter of the stud 104. In one embodiment, the second inner surface 124 may enclose an exposed part 126 of the stud 104 and a stud head 128 such that the second inner surface 124 may also form a loose fit around the stud 104.

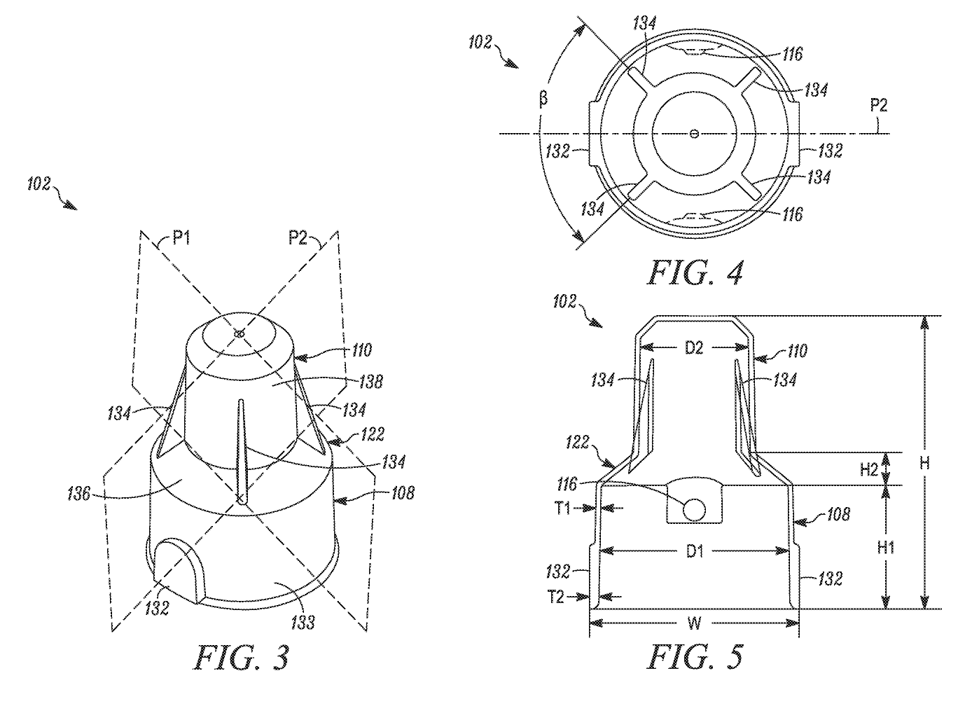

FIGS. 3-5 illustrate various views of the cover 102. As shown, two tabs 132 may be carried by an outer surface 133 of the first section 108 to facilitate easy removal of the cover 102 from the stud and nut assembly 100. In one embodiment, the two tabs 132 may be located in close proximity to the open end 114 of the cover 102. The two tabs 132 may be located in a second plane P2 at opposite ends. The second plane P2 may be substantially perpendicular to the first plane P1, containing the two protruding members 116 of the cover 102. Hence, by pressing the two tabs 132 the two protruding members 116 may be spaced apart, allowing the cover 102 to be easily disengaged from the stud and nut assembly 100.

Moreover, in order to provide increased structural stability, the cover 102 may include a plurality of ribs 134 extending between an outer surface 136 of the tapered section 122 and an outer surface 138 of the second section 110. In one embodiment, the cover 102 may include four ribs 134, and may be also made of a plastic material. In another embodiment, the ribs 134 may be located equidistant from the adjacent ribs 134. For example, in case of four ribs 134, the ribs 134 may be disposed at angle β equal to 90 degrees. A person of ordinary skill in the art will appreciate that the outer surfaces 136 and 138 of the cover 102 may be painted and/or provided with any other type of coating without deviating from the scope and spirit of the invention.

FIG. 4 illustrates a top view of the cover 102. Additionally, FIG. 5 illustrates the side views of the cover 102 taken along the second plane P2.

Referring to the FIG. 5, according to an embodiment of the present disclosure, the cover 102 may include the first section 108 such that the first section 108 may have an inner diameter (Dl) in the range of 70 mm to 75 mm. A thickness (T1) of the first section 108 may lie between 1 mm to 3 mm. Moreover, the each of the tabs 132, which may be located in close proximity with the open end 114, may have a thickness (T2) of 1 mm to 5 mm. A width (W) of the cover 102 may lie between 72 mm to 92 mm. The first section 108 may have a height (H1) of 45 mm to 55 mm. The tapered section 122 may have a height (H2) of 10 mm to 15 mm. Further, the second section 110, integral with the first section 108, may have an inner diameter (D2) of 40 mm to 45 mm. A height (H) of the cover 102 may be from 100 mm to 130 mm.

### INDUSTRIAL APPLICABILITY

During assembly of the engine 1, hydraulic tensioners are used produce a known tension in the stud 104. Moreover, in order to torque down the nut 106 on the stud and nut assembly 100, the hydraulic tensioner may make use of the notches 120 located on the nut 106. At this time, the exposed part 126 of the stud 104 is created. This exposed part 126 of the stud 104 needs to be protected from environmental conditions such as, dust, rust, moisture, and/or debris and other hazards faced due to factors like seawater, diesel fuel, coolants, engine de-greaser, and the like.

The cover 102 described above is fitted onto the stud and nut assembly 100, such that the first inner surface 112 of the cover 102 fits tightly around the nut 106 and the smooth second inner surface 124 covers the exposed part 126 of the stud 104. Further, the interference fit between the two protruding members 116 and the notches 120 provides a sealed enclosure for the stud and nut assembly 100.

The installation of the cover 102 described above also reduces assembly time since the cover 102 needs to be snapped on to the stud and nut assembly 100. The cover 102 hence facilitates in easy removal and re-installation at regular pre-determined intervals. The typical stud protectors in comparison have an inner threaded surface and need to be threaded on by hand and snuggled onto the stud and nut assembly 100; leading to a time consuming installation. Moreover, poorly formed threads and/or exterior burrs on the stud protectors may be avoided with the cover 102.

Further, the cover 102 may be composed of the plastic material. The plastic material of the cover 102 may be capable of withstanding high engine temperatures of approximately 220° C. without meltdown and/or deformation. In contrast, the stud protectors are generally made up of aluminum material; the aluminum having a greater expansion coefficient than the stud 104. As a result, with repeated operation cycles, the stud protectors have a tendency to loosen from the stud and nut assembly 100. Moreover, the cover 102 comprising the plastic material may provide a cost reduction vis-a-vis the use of aluminum in the stud protectors.

In one embodiment, the ribs 134 located on the outer surface of the cover 102 may provide stiffness and increased stability to allow the cover 102 to stay installed on the stud and nut assembly 100 through repeated run cycles. The ribs 134 may also provide mechanical strength and prevent the second section 110 of the cover 102 from collapsing.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A cover for a stud and nut assembly, the cover comprising:
a first section including a first inner surface extending from an open end, and two protruding members configured on the first inner surface; and
a second section integral with the first section, the second section including a second inner surface extending to a closed end.

2. The cover of claim 1 including a tapered section provided between the first section and the second section.

3. The cover of claim 2 further including a plurality of ribs extending between an outer surface of the tapered section and an outer surface of the second section.

4. The cover of claim 1, wherein the two protruding members are located in a first plane at opposite ends.

5. The cover of claim 4 including two tabs carried by an outer surface of the first section, wherein the tabs are located in a second plane at opposite ends, the second plane is substantially perpendicular to the first plane.

6. The cover of claim 1, wherein a diameter of the first inner surface of the first section is greater than a diameter of the nut; and wherein a diameter of the second inner surface of the second section is greater than a diameter of the stud.

7. The cover of claim 1, wherein the protruding members of the cover are configured to engage with notches located on an outer surface of the nut.

8. The cover of claim 1 is composed of a plastic material

9. The cover of claim 8, wherein the plastic material is fiber reinforced plastic.

10. A cover for a stud and nut assembly, the cover comprising:
a first section including a first inner surface extending from an open end, the first section including:
two protruding members configured on a first inner surface of the first section wherein the protruding members are located in a first plane at opposite ends; and
two tabs carried by an outer surface of the first section, wherein the tabs are located in a second plane at opposite ends wherein the second plane is substantially perpendicular to the first plane; and
a second section integral with the first section, the second section including a second inner surface extending to a closed end.

11. The cover of claim 10 including a tapered section provided between the first section and the second section.

12. The cover of claim 11 further including a plurality of ribs extending between an outer surface of the tapered section and an outer surface of the second section.

13. The cover of claim 10, wherein a diameter of the first inner surface of the first section is greater than a diameter of the nut; and wherein a diameter of the second inner surface of the second section is greater than a diameter of the stud.

14. The cover of claim 10, wherein the protruding members of the cover are configured to engage with notches located on an outer surface of the nut.

15. The cover of claim 10 is composed of a plastic material

16. The cover of claim 15, wherein the plastic material is fiber reinforced plastic.

17. An engine comprising:
an engine block portion;
a cylinder head portion;
a stud and nut assembly adapted to fasten the engine block portion and the cylinder head portion; and
a cover for the stud and nut assembly, the cover including:
a first section including a first inner surface extending from an open end, and two protruding members configured on the first inner surface; and
a second section integral with the first section, the second section including a smooth second inner surface extending to a closed end.

18. The engine of claim 17, wherein the cover further includes a tapered section integrating the first section and the second section.

19. The engine of claim 18, wherein the cover further includes a plurality of ribs extending between an outer surface of the tapered section and an outer surface of the second section.

20. The engine of claim 17, wherein the cover further includes two tabs carried by an outer surface of the first section.
